(19) United States
(12) Patent Application Publication
(10) Pub. No.: US 2024/0354782 A1
(43) Pub. Date: Oct. 24, 2024

(54) Customizing the Furniture Resale Market

(71) Applicant: Arsha Bradley, Charlotte, NC (US)

(72) Inventor: Arsha Bradley, Charlotte, NC (US)

(21) Appl. No.: 18/303,893

(22) Filed: Apr. 20, 2023

(51) Int. Cl. G06Q 30/02; G06Q 30/06

(52) U.S. Cl. CPC G06Q 30/02; G06Q 30/06

(57) ABSTRACT

A process and method in which to customize the furniture resale market is disclosed. The ALB process is a systematic method that answers the needs of the consumer while utilizing secondhand furniture and home decor industry practices to streamline and meet the demand of a growing furniture resale market.

### BACKGROUND

The resale industry has become a profitable business within itself; especially in the clothing, jewelry, and auto industries. The resale furniture industry is now gaining traction with at-home moms and do-it-yourselfers. In 2022 the resale home furniture industry was valued at $16 billion and is estimated to double by 2030. Moreso new inventive processes will be needed to meet this demand.

### SUMMARY

The present disclosure details an entire process that helps the consumer with all their home furnishing needs as well as open the doors for industries to cross-train and work alongside one another for a common goal. The improved process disclosed herein, sometimes referred to as the ALB PROCESS, streamlines the consumer's ability to fully customize their furnishings they purchase for their home through the practices of Upholstery/Seamstress Services, Refurbishing Furniture, Rug Tufting, Interior Design, and Rental Furniture. Combining these practices under one entity allows the consumer endless possibilities at various pricing.

### BRIEF DESCRIPTION OF THE DRAWING

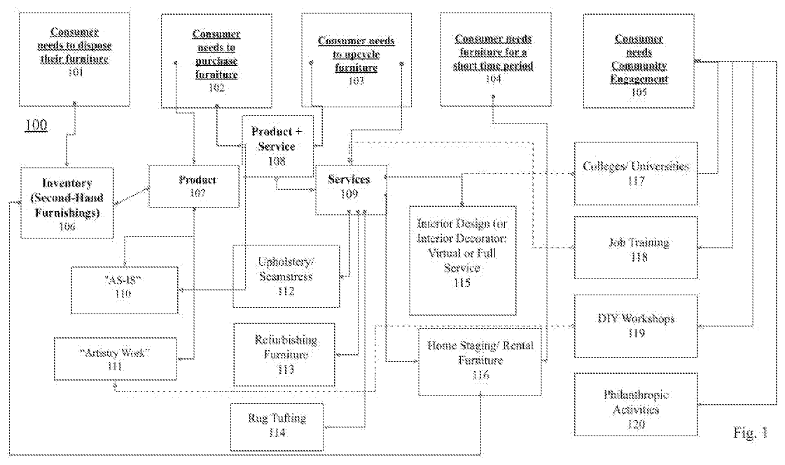

Upon review of this present disclosure further aspects of this system will be detailed in the description FIG. 1., which depicts a flowchart that addresses five consumer needs in conjunction with utilizing the practices mentioned above (Upholstery/Seamstress Services; Refurbishing Furniture; Rug Tufting; Interior Design and Rental Furniture), thus highlighting how to fully meet the demand of a growing resale furniture market.

### DETAILED DESCRIPTION

The goal of this systematic process is to minimize waste while thus creating a fully customizable home shopping experience for the consumer. By combining specific practices, referred to herein as the ALB PROCESS, as now introduced, enhances the ability to solve and exceed the demands of the furniture resale market.

The ALB PROCESS was created to bridge a gap between the various practices in the home decor industry utilizing secondhand furniture as a blank canvas. Unlike factory or custom-built furnishings, utilizing secondhand furnishings has become a low-cost way to decorate a home. Unfortunately, when buying secondhand furniture what you see is typically what you get. There normally aren't any other options in another color or another style and finding matching accessories can be time consuming and costly. Utilizing the ALB PROCESS allows both consumers and entities alike to benefit exponentially by cutting down on costs, time, and waste; whilst building community engagement and promoting healthy home environments.

Turning to FIG. 1, therein depicted starting at 100; the ALB PROCESS begins with the first need of the consumer wanting to sell or get rid of their furnishings 101, which in this creates the inventory/products 106/107. The inventory 106 could be accumulated in a multitude of ways including but not limited to consignment, auctions, estate sales, donations, curb finds, etc. Such inventory/products 106/107 would typically consist of home furnishings such as but not limited to chairs, tables, sofas, dressers, sectionals, etc. By obtaining these inventory/products 106/107 the ALB PROCESS solves the concern of minimizing waste by having a space for the consumer to dispose of their furnishings 101 and while creating inventory 106 for consumers as products 107. This concludes the first need in the ALB PROCESS of consumers needing to dispose of their furnishings 101.

The second need for the consumer in the ALB PROCESS addresses is the need for the consumer to purchase furniture 102. The consumer can then go to “SAID ENTITY'S” website/app/brick-and-mortar to purchase products listed at “AS-IS” 110, indicating no improvements have been made to said furnishings or have the option to choose from an employee and/or sub-contractor's work deemed “Artistry Work” 111. This option gives the consumer the choice to make a regular purchase as if they would in any other market or industry, without hassle or too much of a thought process.

In the ALB PROCESS the consumer has the option to upgrade their product by adding service(s) 108. The service(s) can consist of Upholstery (the practice of removing fabric/coverings and replacing with new fabric/coverings) 112; Refurbishing Furniture (Carpentry, Woodworking, Painting/Staining) 113; Rug Tufting (Utilizing handheld machinery to construct pile/loop rugs) 114; and Interior Design (the practice of designing the interior decoration of a room) 115. These services 109 are crucial in the ALB PROCESS because it gives the consumer full control to customize or personalize their decor allowing the utilization of secondhand furnishings 106 thus providing the options to choose the fabric(s),color(s), stain(s), paint(s) and/or materials; while also allowing the consumer to add any personalization (i.e. name, favorite scripture, photo, etc.) to their purchase, if allotted. These services 109 are also beneficial to “SAID ENTITY” the ALB PROCESS is housed in because it creates a direct streamline of communication across all aspects of the furnishing diaspora. The consumer needing to purchase furniture 102 will feel confident in purchasing multiple products 107 knowing that they will be able to customize their pieces to not only be in congruent with each other but also in congruent with the design dynamics of their home.

“SAID ENTITY” would feel confident knowing they can deliver products and/or services 107/108/109 that directly tie to what the consumer is requesting and to be able to communicate directly with the other services involved, thus creating the ultimate customer satisfaction and experience by providing a product and a service 108. This concludes the second need of a consumer needing to purchase furniture 102.

The ALB PROCESS identifies the third need as consumers needing to upcycle the furniture, they already own 103. Unlike purchasing a product and then upgrading to adding a service 106/110 (108); the ALB PROCESS identified consumers who wanted to keep furniture they already had 103. The services 106 in the ALB PROCESS that are featured as upgrades to a product 107 can also be a standalone service 109 for consumers. This option allows consumers to minimize their costs by utilizing the furniture they already own 103, while also opening the door for other items in their home to be upgraded and customized as a service 109 as well.

Because each furniture piece is considered a blank canvas, it allows the consumer to fully express their imagination and creativity. Personalization is considered a great asset in the consumer's need to upcycle their furniture 103; because the piece they already own has a purpose in their home already.

Secondly, personalizing home decor is known to promote family positivity and sound structure of the home. With today's advances in the creative space, home machinery (i.e., home cutting machines, sewing machines, and heat presses) gives the ability to personalize and customize all materials (including but not limited to vinyl, paper, wood, plastic, acrylic, fabric, etc.) and adhere them to any furnishings made available with proper bonding procedures 108/109. In the practices of Upholstery/Seamstress 112 and Refurbishing services 113, personalization and customization of the consumer's furniture is practical regarding being able to create and/or redesign the piece because “SAID ENTITY” would only have to produce a “one-of-one” product specifically tailored to the consumer's requests 102/103.

In the Rug Tufting service 114 all rugs are made one of a kind tailoring the size, letters/script, colors, and/or images. With a handheld rug tufting gun, “SAID ENTIY” can benefit from creating loop and pile rugs of various sizes and colors for residential and commercial spaces, providing an overwhelming amount of value when tied into the Upholstery/Seamstress 112 and Refurbishing Services 113. Including the Rug Tufting services 114 minimizes cost and time to the consumer to be able to provide proper protection to their flooring that coincides with their home decor.

The Interior Design Service 115 is a key component in the ALB PROCESS; while the other three services 109 (Upholstery/Seamstress 112; Refurbished Furniture 113, and Rug Tufting 114) reside more with the mechanical aspects of the furniture industry. The Interior Design service 115 represents the science and knowledge behind space planning and decor within said space. (*Please note an interior decorator differs from an interior designer due to the credentials that are required to become a Certified Interior Designer in certain states 115). Encompassing an Interior Design service 115 with Certified Interior Designers gives accreditation to “SAID ENTITY” by providing the knowledge of the market and trends in the home decor space to provide the utmost value to the consumer. The Interior Design service 115 also helps consumers create furniture pieces that are aesthetically pleasing and functional for their home 108/115, while also streamlining their bottom line due to the practices of Interior Designers being compensated for the furnishings they typically help choose for the clients' home.

While the Interior Designer service 115 can help the consumer in the residential space they are also able to provide service in the commercial space as well. In today's day and era, short term rental and corporate housing has become a profitable business opting out of the traditional tourist regimen that comes with the standard hotel. The ALB PROCESS can now streamline services and products 107/108/109 to commercial businesses that consist of corporate housing, short term rental or college/student housing that would prefer decor that aligns with their brand, which coincides most, if not all, the services 109 (Upholstery/Seamstress 112; Refurbished Furniture 113; Rug Tufting 114; and Interior Design Services 115) to create a full service option for the consumer to create a personalized home shopping experience 102/103. This concludes the need for if the consumer wants to upcycle their furniture 103.

Another service provided in the ALB PROCESS would be Home Staging/Rental Furniture Services 116, which would tie into the consumer having a need for furniture for a short period of time 104. In the Interior Design industry 115; interior designers are known to work with realtors to stage homes 116; which is why it is pertinent for them to have access to furniture 106/107 at any given time, especially in metropolitan areas with a high population. In the ALB PROCESS; renting furniture 116 is another method of minimizing waste while also providing a secondary usage with minimal costs involved due to the fact that the consumer can either rent from normal furniture inventory 106/107/110 or a finished piece from the “Artistry Work” 111, which vary in terms of practicality and event needed for, thus creating passive income for “SAID ENTITY” on a daily, weekly, or monthly basis.

All five services 109 working congruently (Upholstery/Seamstress 112, Refurbishing Furniture 113, Rug Tufting 114, Interior Design 115, and Home Staging/Rental Furniture Services 116) create an unstopping force in the furniture resale market because it adds a level of customization, personalization, sophistication and intelligence to the art of home decor, ultimately providing the consumer the full-service experience 102/103/104. This concludes the services 109 in the ALB PROCESS.

The last need that caters to the consumer in the ALB PROCESS is the need for the consumer to receive community engagement 105 in the furniture resale industry. Due to the Do-It-Yourself (DIY) culture, some consumers are interested in learning the skill of upholstery 112, refurbishing furniture 113, interior design or decorating 115, and rug tufting 114. Utilizing the new form of virtual interior design (the art of designing a space 155 via a digital program) 115; consumers have more access to learning about what would fit best in their home. The ALB PROCESS fulfills this need by creating community engagement 105 via job training 118, DIY workshops 119, networking events and working with colleges/universities 117 (i.e., educational/internship programs).

Community Engagement 105 is a very important factor in the ALB PROCESS providing infinite jobs 118 to the community; various skill sets; creative thinking; and culturally tailored home decor 111/119. Creating its own microcosm around the furniture resale market. The ALB PROCESS also opens the door for “SAID ENTITY” to provide philanthropic acts 120 of service within their community to help promote community engagement 105 and trust however “SAID ENTITY” sees fit. In the ALB PROCESS “SAID ENTITY” will have the ability to provide services 109 to governmental housing needs (including but not limited to nursing homes, student housing, homeless centers, etc.); while promoting healthy living spaces throughout their city/township as well.

The ALB PROCESS is ideal in a college/university 117 area where forms of training 118 can be provided and consistent with the standard of the market; it also allows “SAID ENTITY” to grow with the consumer's needs in a pivotal point in their lives when so many changes and memories occur. Although the college/university 117 areas are ideal for the ALB PROCESS; this system can work in any metropolitan area or nearby area where there is a cyclical influx of newcomers to that geographical location. This concludes the description of the drawing.

The various skill sets in the ALB PROCESS, described herein, is a system and method where such practices are not typically unified, although described as a full-service process thereby enhanced and improved by the methods described herein, in a manner that is not conventionally available. The methods and systems of this process herein are entirely implemented and executed exclusively to improve the needs and service of the furniture resale market. Although the best methodologies have been particularly described in the foregoing disclosure, it is to be understood that such descriptions have been provided for purposes of illustration only, and that other variations both in form and in detail can be made thereupon by those skilled in the art without departing from the spirit and scope thereof, which is defined first and foremost by the disclosed claim.

What is claimed is:

1. A method and system for improving the furniture resale market;
the process of utilizing second-hand furnishings as a base to customize and/or personalize as a product and/or service in a systematic method;
including the practices of upholstery/seamstress services, refurbishing furniture, rug tufting, interior design, and home staging/rental furniture services;
that ultimately answers the needs of the consumer of where to dispose, purchase, upcycle, rent, and get involved in community engagement to help identify and fulfill a need in the growing furniture resale market.
